(19) United States
(12) Patent Application Publication
(10) Pub. No.: US 2015/0138569 A1
(43) Pub. Date: May 21, 2015

(54) APPARATUS AND METHOD FOR MEASURING GROWTH VOLUME OF PLANT

(71) Applicant: Electronics and Telecommunications Research Institute, Daejeon (KR)

(72) Inventors: Song LI, Daegu (KR); Hae Dong LEE, Daegu (KR); Ae Kyeung MOON, Daegu (KR); Dong Hyun RYU, Daejeon (KR); Soo In LEE, Daejeon (KR)

(73) Assignee: Electronics and Telecommunications Research Institute, Daejeon (KR)

(21) Appl. No.: 14/188,885

(22) Filed: Feb. 25, 2014

(30) Foreign Application Priority Data
Nov. 19, 2013 (KR) 10-2013-0140795

(51) Int. Cl. G01B 11/02

(52) U.S. Cl. CPC G01B 11/02
USPC 356/634

(57) ABSTRACT

Provided are an apparatus and method for measuring a growth volume of a plant. The apparatus includes a measurement unit configured to generate light and measure a circumference length and an internode length of the plant by using a reflection pattern signal of light obtained by reflecting the generated light, and a control unit configured to respectively compare the measured circumference length and internode length of the plant with a previously measured circumference length and internode length of the plant to calculate respective change amounts of the circumference length and internode length of the plant, and calculate a growth volume of the plant by using the calculated change amounts of the circumference length and internode length of the plant.

### CROSS-REFERENCE TO RELATED APPLICATIONS

This application claims priority under 35 U.S.C. §119 to Korean Patent Application No. 10-2013-0140795, filed on Nov. 19, 2013, the disclosure of which is incorporated herein by reference in its entirety.

### TECHNICAL FIELD

The present invention relates to an apparatus and method for measuring a growth volume of a plant, and more particularly, to an apparatus and method for measuring a growth volume of a plant, which easily measure a circumference length and an internode length of a plant by using a plurality of optical devices, and accurately measure a growth volume of a plant on the basis of the measured circumference length value and internode length value of the plant.

### BACKGROUND

To cultivate crops, glass greenhouses or vinyl greenhouses are being widely used. The inside of a greenhouse maintains a higher temperature than the outside by using solar heat, and since most of sunlight passes through glass or vinyl and is transferred to plants, the inside of the greenhouse has a very good environment for cultivation of crops.

An environment of a greenhouse is controlled with time depending on a growth process or a growth state of a crop and a degree of occurrence of crop insect and disease, and thus, growth information of crops in a greenhouse is the most important factor in determining a control level. Therefore, in order to automatically control a greenhouse environment, it is required to collect growth information (for example, a leaf temperature, a leaf humidity, a plant length, a leaf area, an internode length, a sclerocauly, a content of chlorophyll, the number of bearing flowers, the number of bearing fruits, the color of a fruit, etc.) of corps, in addition to weather environment conditions such as an internal temperature, humidity, etc. of a greenhouse.

Generally, a measurement method based on a user's eyes is used for observing a growth and a growth speed of a crop. Crops are most cultivated in the summer where much sunlight is supplied to the crops. However, when weather is greatly changed, it is difficult to predict a total of crop yields for one year, and for this reason, it is difficult to predict specific crops to export, the number of the exported crops, imported crops, and the number of the imported crops.

Moreover, in order to more accurately observe growth of crops and predict the crop yields depending on a weather change, it is necessarily required to accurately measure growth of crops in backwoods. However, there is no means for accurately measuring growth of crops in backwoods, and whenever weather is changed, a user should directly observe the growth of the crops. For this reason, it is difficult to obtain and store accurate crop growth data.

Furthermore, since a user observes growth of crops, an observation time is mismatched, and the frequency number of observation is limited, in observing a growth state of cultivation crops. Also, since a user touches and measures crops with a hand in directly measuring the crops, there is a high probability that an error occurs in measurement data. In addition, much time is expended in measuring growth information of crops, and it is inconvenient to exchange information with a researcher or a management institute. For this reason, the measured growth information cannot be used as research data, and thus, it is difficult to predict the crop yields for one year.

In order to solve such problems, proposed was a system that observes crops by using a zoom-in function or a zoom-out function of a photographing device mounted on an internal ceiling of a greenhouse, but the system cannot accurately measure an actual growth state of the crops due to distances between the photographing device and the crops.

In addition, a ubiquitous-based management system, in which a plurality of sensor nodes for measuring growth environment factors of crops are provided in a region or a greenhouse where the crops are cultivated, was developed. The ubiquitous-based management system monitors a growth state of the crops to collect current state information of the crops by using the sensor nodes, transmits the collected current state information to a mobile terminal through short-distance wireless communication, and controls internal growth conditions of the greenhouse according to a control signal generated by the mobile terminal.

However, the systems measure a growth state of crops by using the sensor nodes fixed to a specific position, and thus have a limitation in more accurately measuring the growth state of the crops.

### SUMMARY

Accordingly, the present invention provides an apparatus and method for measuring a growth volume of a plant, which easily measure a circumference length and an internode length of a plant by using a plurality of optical devices, and accurately measure a growth volume of a plant on the basis of the measured circumference length value and internode length value of the plant.

In one general aspect, an apparatus for measuring a growth volume of a plant includes: a measurement unit configured to generate light, and measure a circumference length and an internode length of the plant by using a reflection pattern signal of light obtained by reflecting the generated light; and a control unit configured to respectively compare the measured circumference length and internode length of the plant with a previously measured circumference length and internode length of the plant to calculate respective change amounts of the circumference length and internode length of the plant, and calculate a growth volume of the plant by using the calculated change amounts of the circumference length and internode length of the plant.

The measurement unit may include: a first measurer configured to measure the circumference length of a stem of the plant by using the light; and a second measurer configured to measure the internode length of the stem of the plant by using the light.

The first measurer may include: a first reflection member configured to have a certain pattern, surround the stem of the plant, and expand in a circumference length direction in proportion to growth of the stem of the plant; a first light transmission unit provided at the first reflection member, and configured to transmit light having arbitrary intensity to the first reflection member; and a first light reception unit configured to receive a reflection pattern signal of the light which is transmitted by the first light transmission unit and is reflected from the first reflection member, and supply the reflection pattern signal of the light to the control unit.

The second measurer may include: a second reflection member connected to the first reflection member in a stem length direction of the plant, and configured to have a certain pattern; a second light transmission unit provided at the second reflection member, and configured to transmit light having arbitrary intensity to the second reflection member; and a second light reception unit configured to receive a reflection pattern signal of the light which is transmitted by the second light transmission unit and is reflected from the second reflection member, and supply the reflection pattern signal of the light to the control unit.

The control unit may include: a pattern recognizer configured to receive a reflection pattern signal supplied from the first light reception unit of the first measurer and a reflection pattern signal supplied from the second light reception unit of the second measurer; a first calculator configured to respectively compare the reflection pattern signals, which are recognized by the pattern recognizer, and reflection pattern signals, which are measured in a previous period, to calculate respective change amounts of the circumference length and internode length of the stem of the plant; and a second calculator configured to calculate a growth volume of the plant by using a difference between the change amounts of the circumference length and internode length of the stem of the plant which are calculated by the first calculator.

The apparatus may further include: a storage unit configured to store the respective change amounts of the circumference length and internode length of the stem of the plant, which are calculated by the first calculator, and the growth volume of the plant which is calculated by the second calculator; and a display unit configured to display the respective change amounts of the circumference length and internode length of the stem of the plant, which are calculated by the first calculator, and the growth volume of the plant which is calculated by the second calculator.

The apparatus may further include a communication unit configured to transmit the respective change amounts of the circumference length and internode length of the stem of the plant, which are calculated by the first calculator, and the growth volume of the plant, which is calculated by the second calculator, to a remote server over a wired or wireless network.

The light generated by the measurement unit may be laser or infrared light.

In another general aspect, a method of measuring a growth volume of a plant includes: generating light, and measuring a circumference length and an internode length of the plant by using a reflection pattern signal of light obtained by reflecting the generated light; respectively comparing the measured circumference length and internode length of the plant with a previously measured circumference length and internode length of the plant to calculate respective change amounts of the circumference length and internode length of the plant; and calculating a growth volume of the plant by using the calculated change amounts of the circumference length and internode length of the plant.

The measuring may include: transmitting light having arbitrary intensity to a first reflection member that is configured to have a certain pattern, surround the stem of the plant, and expand in a circumference length direction in proportion to growth of the stem of the plant; and receiving a reflection pattern signal of a light reflected by the first reflection member.

The measuring may include: transmitting light having arbitrary intensity to a second reflection member that is connected to the first reflection member in a stem length direction of the plant, and is configured to have a certain pattern; and receiving a reflection pattern signal of light reflected by the second reflection member.

The calculating of respective change amounts may include: receiving a reflection pattern signal reflected by the first reception member and a reflection pattern signal reflected by the second reception member; respectively comparing the recognized reflection pattern signals and reflection pattern signals, which are measured in a previous period, to calculate respective change amounts of the circumference length and internode length of the stem of the plant; and calculating a growth volume of the plant by using a difference between the calculated change amounts of the circumference length and internode length of the stem of the plant.

The method may further include: storing the calculated change amounts of the circumference length and internode length of the stem of the plant and the calculated growth volume of the plant; and displaying the calculated change amounts of the circumference length and internode length of the stem of the plant and the calculated growth volume of the plant.

The method may further include transmitting the calculated change amounts of the circumference length and internode length of the stem of the plant and the calculated growth volume of the plant to a remote server over a wired or wireless network.

Other features and aspects will be apparent from the following detailed description, the drawings, and the claims.

### BRIEF DESCRIPTION OF THE DRAWINGS

FIG. 1 is a diagram illustrating an example in which an apparatus for measuring a growth volume of a plant according to the present invention is applied to a plant.

FIG. 2 is a block diagram illustrating the apparatus for measuring a growth volume of a plant according to the present invention.

FIG. 3 is a block diagram illustrating a detailed configuration of a control unit of FIG. 2.

A portion (a) of FIG. 4 is a diagram illustrating a reflection pattern of light received by a pattern recognizer of FIG. 3.

A portion (b) of FIG. 4 is a diagram illustrating a change amount of a reflection pattern which is obtained by comparing a reflection pattern of currently received light and a reflection pattern of light which is received in a previous measurement period.

FIG. 5 is a flowchart illustrating a method of measuring a growth volume of a plant according to the present invention.

### DETAILED DESCRIPTION OF EMBODIMENTS

Hereinafter, an apparatus and method for measuring a growth volume of a plant according to embodiments of the present invention will be described in detail with reference to the accompanying drawings.

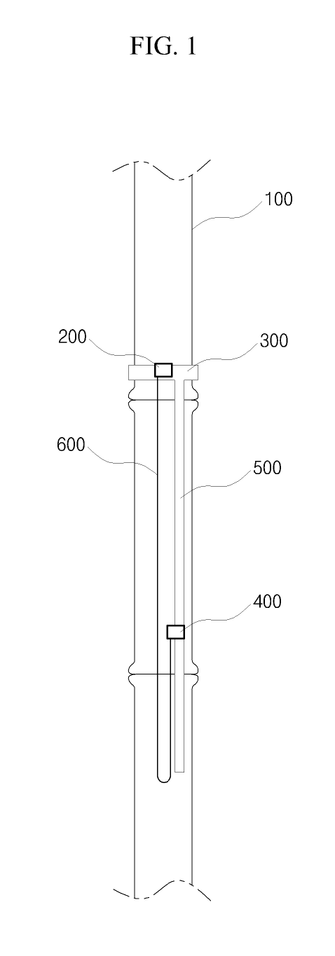

FIG. 1 is a diagram illustrating an example in which an apparatus for measuring a growth volume of a plant according to the present invention is applied to a plant.

As illustrated in FIG. 1, the apparatus for measuring a growth volume of a plant according to the present invention includes a first optical device 200 that is provided at a first node of a plant 100, and the first optical device 200 is connected to a first reflection member 300 having a certain pattern. That is, the first reflection member 300 is provided in a buckle (not shown), which is provided in the first optical device 200, to surround a stem of the plant 100. Therefore, when a stem circumference of the plant 100 grows, the first reflection member 300 is inserted into the buckle, and thus, the first optical device 200 moves by a certain distance from a first-provided position to a left or right side. That is, when the circumference of the stem grows, the first reflection member 300 expands, and thus, the first optical device 200 moves to a left or right side.

Due to the distance movement of the first optical device 200, a change occurs between a reflection pattern of light (which is recognized by the first optical device 200 and is reflected by the first reflection member 300) and a previously measured reflection pattern of light reflected by the first reflection member 300.

Therefore, a length change of the stem circumference of the plant 100 is measured based on a change amount of the reflection pattern of the light.

A second reflection member 500 is connected to a portion vertical to the first reflection member 300, namely, to a lower side of the stem of the plant 100, and a second optical device 400 is provided at the second reflection member 500 with a buckle in the same scheme as that of the first optical device 200. Here, the first and second optical devices 200 and 400 may be provided to have opposite transmission and reception directions of light. That is, since the first optical device 200 measures a length change of the stem circumference of the plant 100, the first optical device 200 is provided to laterally move according to a direction in which the first reflection member 300 expands, but since the second optical device 400 measures a change in an internode length of the stem of the plant 100, the second optical device 400 is provided to have a light transmission and reception direction opposite to that of the first optical device 200.

The second reflection member 500 moves to an upper side according to growth of the internode length of the stem of the plant 100, and thus, the second optical device 400 moves in the same direction as that of the second reflection member 500. When the second reflection member 500 moves to the upper side, the second optical device 400 measures a pattern change of light reflected from the second reflection member 500 to measure a length growth change of the stem of the plant 100.

That is, when the second optical device 400 vertically moves, a change occurs between a reflection pattern of light (which is recognized by the second optical device 400 and is reflected by the second reflection member 500) and a previously measured reflection pattern of light reflected by the second reflection member 500.

The first and second reflection members 300 and 500 have a certain pattern, and have a belt shape that is vertically connected to each other.

Therefore, an internode length change of the stem of the plant 100 is measured based on a change amount of the reflection pattern of the light.

A signal cable (a power and signal cable) 600 is connected between the first and second optical devices 200 and 400, and transfers power from the first optical device 200 to the second optical device 400. The first optical device 200 checks a measurement period which is set by a user, and supplies a measurement start signal (i.e., a control signal for driving the second optical device 500) according to the measurement period. To perform such a power supply operation, a power supply for supplying the power may be built into the first optical device 200. Here, the power supply may be a battery.

The first optical device 200 includes a device that receives a reflection pattern signal of light (which is reflected by the second reflection member 500 and is measured by the second optical device 400) to measure a change amount of the internode length of the stem of plant 100 and to measure a change amount of the stem circumference length of the plant 100 based on autonomous optical measurement, calculates an actual growth volume of the plant 100 by using the measured change amounts, and stores the calculated growth data of the plant 100 in a memory, displays the calculated growth data of the plant 100 in a display unit, or transmits the calculated growth data of the plant 100 to a server (not shown) over a network. A detailed configuration and operation of the device will be described below in detail.

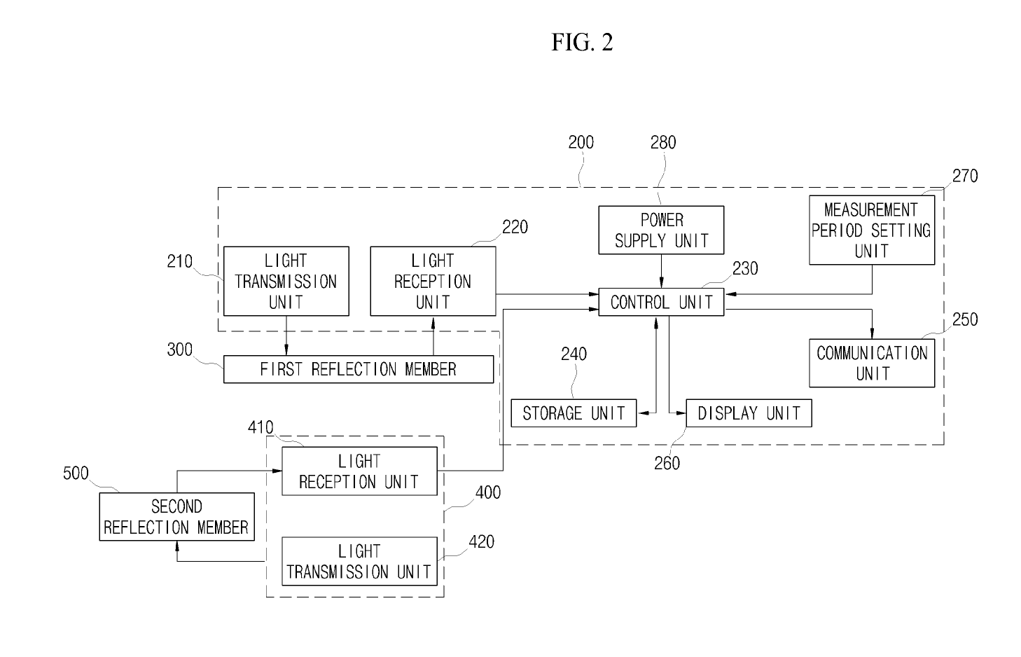

A detailed configuration and operation of the apparatus for measuring a growth volume of a plant according to the present invention will be described in detail with reference to FIGS. 2 to 4.

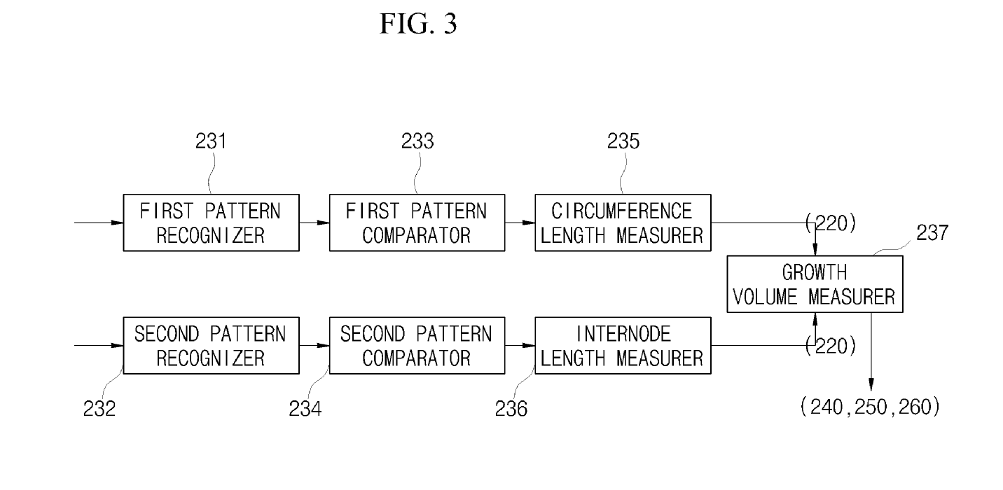

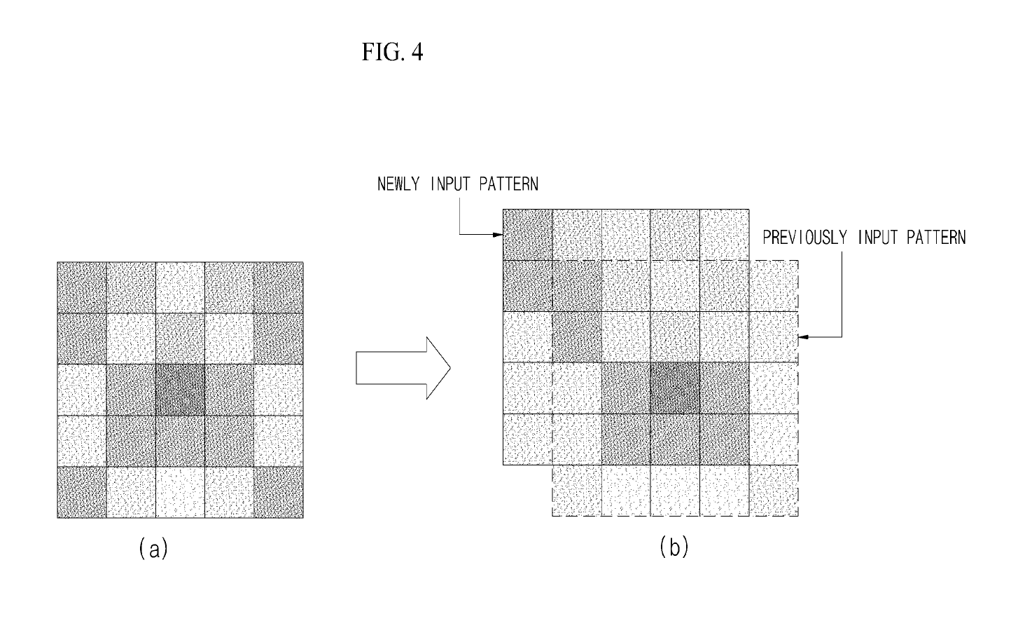

FIG. 2 is a block diagram illustrating the apparatus for measuring a growth volume of a plant according to the present invention. FIG. 3 is a block diagram illustrating a detailed configuration of a control unit of FIG. 2. A portion (a) of FIG. 4 is a diagram illustrating a reflection pattern of light received by a pattern recognizer of FIG. 3. A portion (b) of FIG. 4 is a diagram illustrating a change amount of a reflection pattern which is obtained by comparing a reflection pattern of currently received light and a reflection pattern of light which is received in a previous measurement period.

As illustrated in FIG. 2, the apparatus for measuring a growth volume of a plant according to the present invention includes the first and second optical devices 200 and 400 and the first and second reflection members 300 and 500.

First, a power supply unit 280 of the first optical device 200 supplies the power to elements of the first optical device 200, and also supplies the power to the second optical device 400 through a control unit 230.

The first optical device 200, as illustrated in FIG. 1, is a device for measuring a length change of the stem circumference of the plant 100, and includes a light transmission unit 210, a light reception unit 220, the control unit 230, a storage unit 240, a communication unit 250, a display unit 250, a measurement period setting unit 270, and the power supply unit 280. Here, the light transmission unit 210 and the light reception unit 220 are provided at a lower portion of the first optical device 200 illustrated in FIG. 1. The light transmission unit 210 transmits light to the first reflection member 300, and the light reception unit 220 receives the light reflected from the first reflection unit 300.

The second optical device 400, as illustrated in FIG. 1, is a device for measuring a change of the internode length of the plant 100, and includes a light reception unit 410 and a light transmission unit 420. Here, the light transmission unit 420 and the light reception unit 410 are provided at a lower portion of the second optical device 400 illustrated in FIG. 1. The light transmission unit 420 transmits light to the second reflection member 500, and the light reception unit 410 receives the light reflected from the second reflection unit 500.

The measurement period setting unit 270 sets a driving period for driving the first and second optical devices 200 and 400 according to a user's selection, and provides the driving period to the control unit 230. For example, the driving period of the first and second optical devices 200 and 400 is set in units of time, day, and month, and when the driving period arrives, the measurement period setting unit 270 supplies a driving signal to the control unit 230. Therefore, the control unit 230 supplies a driving control signal to the light transmission unit 210 and the light reception unit 420 of the second optical device 400 according to the driving signal which is supplied according to the driving period.

The light transmission unit 210 of the first optical device 200 generates light, such as laser or infrared light, according to a driving control signal which is supplied from the control unit 230 according to the driving period, and transmits the light to the first reflection member 300.

The light reception unit 220 receives the light reflected from the first reflection member 300, and the received light has a certain pattern. That is, the first reflection member 300 has a certain pattern, and thus, the certain pattern of the reflected light is the same as the pattern of the first reflection member 300.

The light transmission unit 420 of the second optical device 400 generates light according to the driving control signal which is supplied from the control unit 230 of the first optical device 200 according to the driving period, and transmits the light to the second reflection member 500. Here, the light generated by the light reception unit 420 may be laser or infrared light.

The light reception unit 410 of the second optical device 400 receives the light reflected from the second reflection member 500 according to the light transmission of the light transmission unit 420, and supplies a reflection pattern signal of the received light to the control unit 230 of the first optical device 200. Here, the second reflection member 500 also has a certain pattern as in the first reflection member 300, and thus, the reflected light also has a certain pattern.

The control unit 230 of the first optical device 200 recognizes a pattern signal, supplied from the light reception unit 220 of the first optical device 200, and a pattern signal which is supplied from the light reception unit 410 of the second optical device 400. The control unit 230 compares each of the recognized pattern signals with patterns which are respectively supplied from the light reception unit 220 and the light reception unit 410 of the second optical device 400 in a previous measurement period and are stored in the storage unit 240.

In other words, the control unit 230 of the first optical device 200 compares a reflection pattern signal of the light supplied from the light reception unit 220 and a reflection pattern of previous light stored in the storage unit 240 to measure a change amount of a pattern, and calculates a length change amount of the stem circumference of the plant 100 by using the measured change amount.

Moreover, the control unit 230 compares a reflection pattern signal of the light supplied from the light reception unit 410 of the second optical device 400 and a reflection pattern (which is received from the light reception unit 410 in a previous measurement period and is stored in the storage unit 240) to measure a change amount of a pattern, and calculates a change amount of the stem length (i.e., the internode length) of the plant 100 by using the measured change amount.

The control unit 230 calculates a difference between the calculated change amounts of the stem circumference and internode length of the plant 100 to calculate a growth change amount of the plant 100, and stores the calculated change amounts of the stem circumference and internode length of the plant 100 and growth volume information of the plant 100 in the storage unit 240.

Moreover, the control unit 230 may display the information in the display unit 260, or transmit the information to a remote server (not shown) over the network by using the communication unit 250. Here, the display unit 260 may be configured with a liquid crystal display (LCD) or a light emitting diode (LED).

A detailed configuration and operation of the control unit 230 of the first optical device 200 will now be described in detail with reference to FIGS. 3 and 4.

First, as illustrated in FIG. 3, the control unit 230 includes first and second pattern recognizers 231 and 232, first and second pattern comparators 233 and 234, a circumference length measurer 235, an internode length measurer 236, and a growth volume measurer 237.

The first pattern recognizer 231 recognizes a light reflection pattern of the first reflection member 300 which is received from the light reception unit 220 of the first optical device 200, and supplies the recognized light reflection pattern to the first pattern comparator 233.

The second pattern recognizer 232 recognizes a light reflection pattern of the second reflection member 500 which is received from the light reception unit 410 of the second optical device 400, and supplies the recognized light reflection pattern to the second pattern comparator 234.

The first pattern comparator 233 compares the light reflection pattern of the first reflection member 300 (which is supplied from the first pattern recognizer 231) and the light reflection pattern of the first reflection member 300 which is measured in a previous period and is stored in the storage unit 240, deletes a reflection pattern signal of the first reflection member 300 corresponding to the previous period, and stores a currently received reflection pattern signal value of the first reflection member 300 in the storage unit 240.

The second pattern comparator 234 compares the light reflection pattern of the second reflection member 500 (which is supplied from the second pattern recognizer 232) and the light reflection pattern of the second reflection member 500 which is measured in a previous period and is stored in the storage unit 240, deletes a reflection pattern signal of the second reflection member 500 corresponding to the previous period, and stores a currently received reflection pattern signal value of the second reflection member 500 in the storage unit 240.

The circumference length measurer 235 measures a change amount of the reflection pattern of the first reflection member 300 compared by the first pattern comparator 233 to calculate a change amount of the stem circumference length of the plant 100, stores information about the change amount of the stem circumference length in the storage unit 240, and supplies the information about the change amount of the stem circumference length to the growth volume measurer 237. Here, an example of a change in the reflection pattern of the first reflection member 300 is illustrated in FIG. 4. That is, the portion (a) of FIG. 4 illustrates a currently received reflection pattern of the first reflection member 300, and the portion (b) of FIG. 4 illustrates an example in which a change amount of a reflection pattern is calculated by comparing a reflection pattern, which is received in a previous period, and a currently received reflection pattern. In other words, a reflection pattern being changed denotes the length of the stem circumference of the plant 100 being changed.

Therefore, the circumference length measurer 235 calculates a change amount of the stem circumference length of the plant 100, stores the calculated change amount in the storage unit 240, and supplies the calculated change amount to the growth volume measurer 237.

The internode length measurer 236 measures a change amount of the reflection pattern of the second reflection member 500 compared by the second pattern comparator 234 to calculate a change amount of the internode length of the plant 100, stores the calculated change amount of the internode length in the storage unit 240, and supplies the calculated change amount of the internode length to the growth volume measurer 237. Here, an example of a change in the reflection pattern of the second reflection member 500 is illustrated in FIG. 4, and a method of calculating the change amount is the same as the calculation method performed by the circumference length measurer 235. That is, the light reflection pattern of the second reflection member 500 being changed denotes the internode length of the plant 100 being changed.

Therefore, the internode length measurer 236 calculates a change amount of the internode length of the plant 100, stores the calculated change amount in the storage unit 240, and supplies the calculated change amount to the growth volume measurer 237.

The growth volume measurer 237 calculates an actual growth volume of the plant 100 by using the change amount of the stem circumference length of the plant 100 which is supplied from the circumference length measurer 235 and the change amount of the internode length of the plant 100 which is supplied from the internode length measurer 236. That is, the actual growth volume of the plant 100 is a value that is obtained by subtracting the change amount of the internode length from the change amount of the stem circumference length.

As described above, the growth volume measurer 237 may store the actual growth volume of the plant 100 in the storage unit 240. Alternatively, in order for a user to check corresponding information, the growth volume measurer 237 may display the actual growth volume of the plant 100 in the display unit 260 while storing the actual growth volume of the plant 100 in the storage unit 240.

The growth volume measurer 237 may supply the calculated actual growth volume of the plant 100 to the communication unit 250, and the communication unit 250 may transmit the calculated actual growth volume of the plant 100 to the remote server over a wired/wireless network, thereby storing and managing information about the actual growth volume of the plant 100.

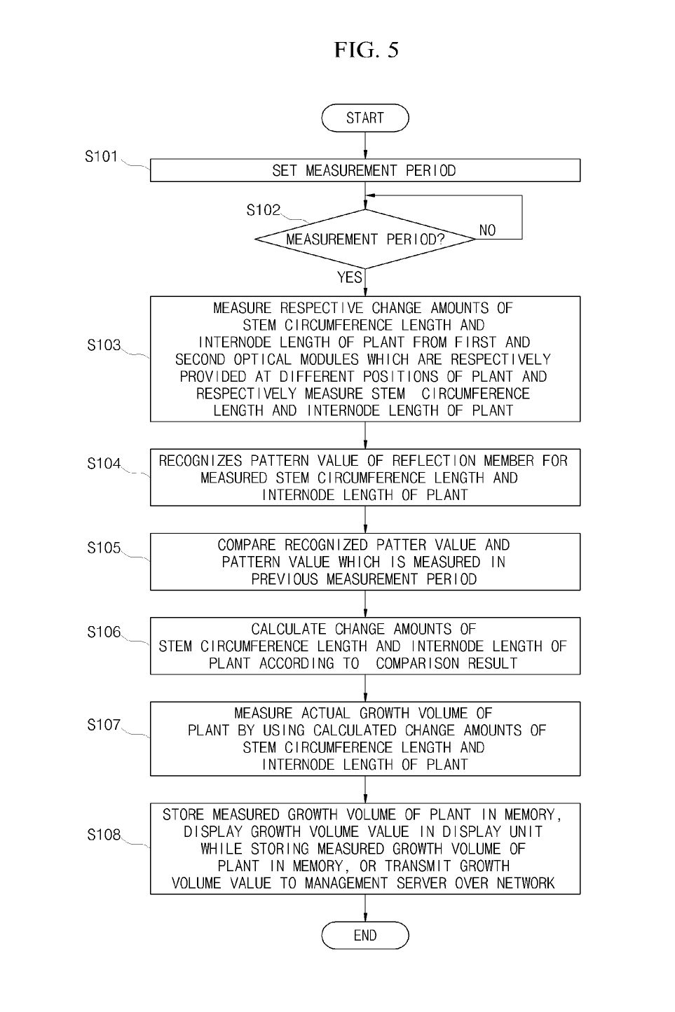

A method of measuring a growth volume of a plant according to the present invention, corresponding to the operation of the apparatus for measuring a growth volume of a plant according to the present invention, will be described in detail with reference to FIG. 5.

FIG. 5 is a flowchart illustrating a method of measuring a growth volume of a plant according to the present invention.

As illustrated in FIG. 5, first, when power is supplied to the first and second optical devices 200 and 400, a user sets a measurement period for measuring a stem circumference length and an internode length of a plant, in operation S101.

Subsequently, the method determines whether the set measurement period arrives, in operation S102.

When it is determined that the set measurement period arrives, the method measures respective change amounts of the stem circumference length and internode length of the plant from the optical modules of the first and second optical devices 200 and 400 which are respectively provided at different positions of the plant and respectively measure the stem circumference length and internode length of the plant, in operation S103. Here, a method of measuring the stem circumference length and internode length of the plant has been described above in describing the apparatus, and thus, its detailed description is not provided.

Subsequently, in operation S104, the method recognizes a light reflection pattern of the first reflection member 300 for the measured stem circumference length of the plant, and recognizes a light reflection pattern of the second reflection member 500 for the measured internode length of the plant.

In operation S105, the method compares a reflection pattern value (which is measured in a previous measurement period) and the recognized light reflection pattern value of the first reflection member 300 for the stem circumference length of the plant, and compares a reflection pattern value (which is measured in the previous measurement period) and the recognized light reflection pattern value of the second reflection member 500 for the internode length of the plant.

In operation S106, the method calculates a change amount of the stem circumference length of the plant, and calculates a change amount of the internode length of the plant.

In operation S107, an actual growth volume of the plant is calculated by using the change amount of the stem circumference length of the plant and the change amount of the internode length of the plant which are calculated in operation S106.

Subsequently, information about the change amounts of the stem circumference length and internode length of the plant (which are calculated in operation S106) and the actual growth volume of the plant (which is calculated in operation S107) is stored in a memory. Furthermore, in order for the user to check the information, a display unit may display the information, or the information may be transmitted to the remote server over the wired/wireless network so that the growth volume of the plant is remotely stored and managed, in operation S108.

According to the embodiments of the present invention, a circumference length and an internode length of a plant are easily measured by using a plurality of optical devices, and a growth volume of the plant is accurately measured based on the measured circumference length value and internode length value of the plant. Accordingly, a growth state and the like of a crop can be accurately measured in agricultural research, and a growing part between nodes of the crop can be accurately measured.

Moreover, in controlling an internal environment of a greenhouse, a growth state of a plant is automatically measured according to the above-described method, and the greenhouse system is controlled to maintain an internal environment state of the greenhouse as the optimal environment state by using the measured growth data of the plant.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An apparatus for measuring a growth volume of a plant, the apparatus comprising:
a measurement unit configured to generate light, and measure a circumference length and an internode length of the plant by using a reflection pattern signal of light obtained by reflecting the generated light; and
a control unit configured to respectively compare the measured circumference length and internode length of the plant with a previously measured circumference length and internode length of the plant to calculate respective change amounts of the circumference length and internode length of the plant, and calculate a growth volume of the plant by using the calculated change amounts of the circumference length and internode length of the plant.

2. The apparatus of claim 1, wherein the measurement unit comprises:
a first measurer configured to measure the circumference length of a stem of the plant by using the light; and
a second measurer configured to measure the internode length of the stem of the plant by using the light.

3. The apparatus of claim 2, wherein the first measurer comprises:
a first reflection member configured to have a certain pattern, surround the stem of the plant, and expand in a circumference length direction in proportion to growth of the stem of the plant;
a first light transmission unit provided at the first reflection member, and configured to transmit light having arbitrary intensity to the first reflection member; and
a first light reception unit configured to receive a reflection pattern signal of the light which is transmitted by the first light transmission unit and is reflected from the first reflection member, and supply the reflection pattern signal of the light to the control unit.

4. The apparatus of claim 3, wherein the second measurer comprises:
a second reflection member connected to the first reflection member in a stem length direction of the plant, and configured to have a certain pattern;
a second light transmission unit provided at the second reflection member, and configured to transmit light having arbitrary intensity to the second reflection member; and
a second light reception unit configured to receive a reflection pattern signal of the light which is transmitted by the second light transmission unit and is reflected from the second reflection member, and supply the reflection pattern signal of the light to the control unit.

5. The apparatus of claim 4, wherein the control unit comprises:
a pattern recognizer configured to receive a reflection pattern signal supplied from the first light reception unit of the first measurer and a reflection pattern signal supplied from the second light reception unit of the second measurer;
a first calculator configured to respectively compare the reflection pattern signals, which are recognized by the pattern recognizer, and reflection pattern signals, which are measured in a previous period, to calculate respective change amounts of the circumference length and internode length of the stem of the plant; and
a second calculator configured to calculate a growth volume of the plant by using a difference between the change amounts of the circumference length and internode length of the stem of the plant which are calculated by the first calculator.

6. The apparatus of claim 5, further comprising:
a storage unit configured to store the respective change amounts of the circumference length and internode length of the stem of the plant, which are calculated by the first calculator, and the growth volume of the plant which is calculated by the second calculator; and
a display unit configured to display the respective change amounts of the circumference length and internode length of the stem of the plant, which are calculated by the first calculator, and the growth volume of the plant which is calculated by the second calculator.

7. The apparatus of claim 6, further comprising a communication unit configured to transmit the respective change amounts of the circumference length and internode length of the stem of the plant, which are calculated by the first calculator, and the growth volume of the plant, which is calculated by the second calculator, to a remote server over a wired or wireless network.

8. The apparatus of claim 1, wherein the light generated by the measurement unit is laser or infrared light.

9. A method of measuring a growth volume of a plant, the method comprising:
generating light, and measuring a circumference length and an internode length of the plant by using a reflection pattern signal of light obtained by reflecting the generated light;
respectively comparing the measured circumference length and internode length of the plant with a previously measured circumference length and internode length of the plant to calculate respective change amounts of the circumference length and internode length of the plant; and
calculating a growth volume of the plant by using the calculated change amounts of the circumference length and internode length of the plant.

10. The method of claim 9, wherein the measuring comprises:
transmitting light having arbitrary intensity to a first reflection member that is configured to have a certain pattern, surround the stem of the plant, and expand in a circumference length direction in proportion to growth of the stem of the plant; and
receiving a reflection pattern signal of a light reflected by the first reflection member.

11. The method of claim 10, wherein the measuring comprises:
transmitting light having arbitrary intensity to a second reflection member that is connected to the first reflection member in a stem length direction of the plant, and is configured to have a certain pattern; and
receiving a reflection pattern signal of light reflected by the second reflection member.

12. The method of claim 11, wherein the calculating of respective change amounts comprises:
receiving a reflection pattern signal reflected by the first reception member and a reflection pattern signal reflected by the second reception member;
respectively comparing the recognized reflection pattern signals and reflection pattern signals, which are measured in a previous period, to calculate respective change amounts of the circumference length and internode length of the stem of the plant; and
calculating a growth volume of the plant by using a difference between the calculated change amounts of the circumference length and internode length of the stem of the plant.

13. The method of claim 12, further comprising:
storing the calculated change amounts of the circumference length and internode length of the stem of the plant and the calculated growth volume of the plant; and
displaying the calculated change amounts of the circumference length and internode length of the stem of the plant and the calculated growth volume of the plant.

14. The method of claim 12, further comprising transmitting the calculated change amounts of the circumference length and internode length of the stem of the plant and the calculated growth volume of the plant to a remote server over a wired or wireless network.

15. The method of claim 9, wherein the generated light is laser or infrared light.
